(19) United States
(12) Patent Application Publication
(10) Pub. No.: US 2020/0410975 A1
(43) Pub. Date: Dec. 31, 2020

(54) AUDIO SYNTHESIS METHOD, COMPUTER APPARATUS, AND STORAGE MEDIUM

(71) Applicant: Shanghai Edaysoft Co., Ltd., Shanghai (CN)

(72) Inventor: Keyiming Zhang, Shanghai (CN)

(73) Assignee: SHANGHAI EDAYSOFT CO., LTD., Shanghai (CN)

(21) Appl. No.: 16/657,195

(22) Filed: Oct. 18, 2019

(30) Foreign Application Priority Data
Jun. 28, 2019 (CN) 201910580115.5

(51) Int. Cl. G10L 13/00; G10L 15/00; G10L 25/27; G11B 27/031

(52) U.S. Cl. CPC G10L 13/00; G11B 27/031; G10L 25/27; G10L 15/00

(57) ABSTRACT

The present disclosure relates to an audio synthesis method, a computer apparatus and storage medium for synthesizing the audio. The method includes: obtaining an original audio; identifying a rhythm point in the original audio, and labeling an audio effect area in the original audio according to the rhythm point; obtaining an audio effect audio corresponding to the audio effect area, and synthesizing an audio effect of the audio effect audio into the audio effect area of the original audio to obtain a synthesized audio.

### TECHNICAL FIELD

The present disclosure relates to computer technical fields, and more particularly to an audio synthesis method, computer apparatus and storage medium.

### BACKGROUND

With the development of computer technology and network information, people have begun to transmit and publish information via networks. The Internet has become an important part of people's entertainment and work, while digital audios have become a popular form of network data. With the development of the big data era, applications of audio data will also become increasingly wider. After digital audio providers publish audio files to the Internet, users may download the audio resources and use them as their own ring tone, website background music, and the like.

### SUMMARY

According to various embodiments of the present disclosure, an audio synthesis method, a computer apparatus, and a storage medium for synthesizing an audio are provided. The audio synthesis method includes: obtaining an original audio; identifying a rhythm point in the original audio, and labeling an audio effect area in the original audio according to the rhythm point; and obtaining an audio effect audio corresponding to the audio effect area, and synthesizing an audio effect in the audio effect audio into the audio effect area of the original audio to obtain a synthesized audio.

A computer apparatus includes one or more processors, and a memory storing computer-readable program, which, when executed by the one or more processors cause the one or more processors to perform the above mentioned method.

At least one one-transitory computer-readable storage medium includes computer-readable instructions, which, when executed by one or more processors, cause the one or more processors to perform the above mentioned method.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

To illustrate the technical solutions of the embodiments or the prior art more clearly, the accompanying drawings for describing the embodiments or the prior art are introduced briefly in the following. Apparently, the accompanying drawings in the following description are only some embodiments of the present invention, and persons of ordinary skill in the art can derive accompany drawings of other embodiments from these accompanying drawings without creative efforts.

FIG. 1 is a schematic diagram illustrating an environment adapted for an audio synthesis method according to an embodiment.

FIG. 2 is a flowchart of a method of synthesizing the audio according to an embodiment.

FIG. 3 is a flowchart of a method for creating a background music file according to an embodiment.

FIG. 4 is a block diagram of a device for synthesizing the audio according to an embodiment.

FIG. 5 is a block diagram of the computer apparatus according to an embodiment.

### DETAILED DESCRIPTION OF THE EMBODIMENTS

In order to make the objects, technical solutions and advantages of the present disclosure more comprehensible, the present disclosure will be described in detail below with reference to the accompanying drawings and embodiments. It should be understood that the detailed embodiments described herein are merely to explain the present disclosure, but not intended to limit the same.

Conventionally, after downloading an original audio from Internet, the editing of the original audio generally includes editing the length of audios, splicing the audios, and the like. When a user wants to add other audio effects into the original audio, it is required to manually locate addition positions of the audio effects, and add the audio effects one by one. However, if it is desired to add audio effects to rhythm points of the original audio, it is required to repeat identifying and adding operations by multiply times, which is cumbersome.

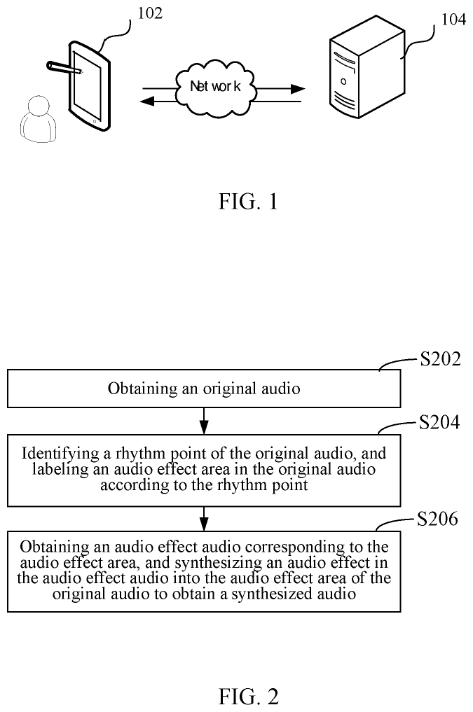

According to an embodiment, an audio synthesis method is provided. The method may be implemented in an application environment as shown in FIG. 1. A terminal 102 communicates with a server 104 via networks. The server 104 implements the method for synthesizing the audio, and publishes the synthesized audio to the terminal 102. The terminal 102 may download the synthesized audio from the server 104, and play the synthesized audio. The terminal 102 may include, but not limited to, computer, laptop, smart phone, tablet, and portable wearable device. The server 104 may be implemented with a separate server or a server farm comprised of a plurality of servers.

In an embodiment, the audio synthesis method is provided, as shown in FIG. 2. To illustrate by way of example applying the method to the server shown in FIG. 1, the method includes the following steps.

At step S202, an original audio is obtained.

The original audio is an audio to which audio effects will be synthesized by the server. The original audio may be in a common audio format, such as mp3, WMA, WAV, and the like. The content of the original audio may be a song, a piece of music, or the like. When synthesizing an audio effect into the original audio, the server first obtains the original audio into which the audio effect is to be added.

At step S204, a rhythm point of the original audio is identified, and an audio effect area is labeled in the original audio according to the rhythm point.

The rhythm point is a point obtained by identifying the rhythm of the original audio by the server and configured to characterize the rhythm of the corresponding original audio. The server may identify a position of the rhythm point in the music file according to a preset rhythm identifying algorithm. The rhythm identifying algorithm may include obtaining a frequency spectrum corresponding to the original audio when playing the original audio, and capturing a repeated frequency band in the frequency spectrum. Alternatively, the rhythm point may be also identified according to the strength, level and other factors of the sound when playing the original audio.

The audio effect area is an area, into which the audio effect is to be added, obtained according to the identified rhythm point. The audio effect area may coincide with the rhythm point, that is, the audio effect is added exactly at the rhythm point of the original audio. It may also be adjusted according to the practical playback effect of the added audio effect. For example, the audio effect area may be configured as a time interval starting from the rhythm point on and lasting for several seconds, or the like. After the server obtains all of the audio effect areas into which audio effects are to be added in the original audio, time intervals of the playback of the original audio may be used to represent these audio effect areas. For example, the area of the original audio from the 1 minute to the 1 minute 2 second can be regarded as an audio effect area, and the time interval of the original audio from the 1 minute 30 second to the 1 minute 33 second can be regarded as another audio effect area. Optionally, the length of the audio effect area may also be adjusted according to the duration of the to-be-added audio effect or the type of the rhythm point. As for a gunshot audio effect lasting for 1 S, the audio effect area may be configured as a time interval containing the rhythm point and lasting for 1 S.

At step S206, an audio effect audio corresponding to the audio effect area is obtained, and the audio effect in the audio effect audio is synthesized into the audio effect area in the original audio to obtain the synthesized audio.

The audio effect audio is an audio file containing the content of the audio effect added into the original audio. The audio effect may include a piece of music, a gunshot, a tweet, and the like. The audio effect audio may be in a common audio format, such as mp3, WMA, WAV and the like.

Specifically, after the audio effect area for the to-be-added audio effect is labeled in the original audio, the server obtains the audio effect audio corresponding to the audio effect to be synthesized into the audio effect area, and the audio effect audio is synthesized into the audio effect area already labeled in the original audio to obtain the synthesized audio.

In the above embodiment of the audio synthesis method, the server identifies the audio effect area in which the audio effect is to be added in the original audio according to the rhythm point of the original audio, and synthesizes the audio effect in the audio effect audio into the audio effect area, so as to obtain the synthesized audio in which the corresponding audio effect is added to the rhythm point of the original audio. The server identifies all of the audio effect areas in the original audio once according to the rhythm identifying algorithm, and adds the audio effect directly into the corresponding audio effect areas. Compared with the conventional method in which the audio effect is added area by area, the above-described method can achieve a simple and quick adding of the audio effect to the rhythm point.

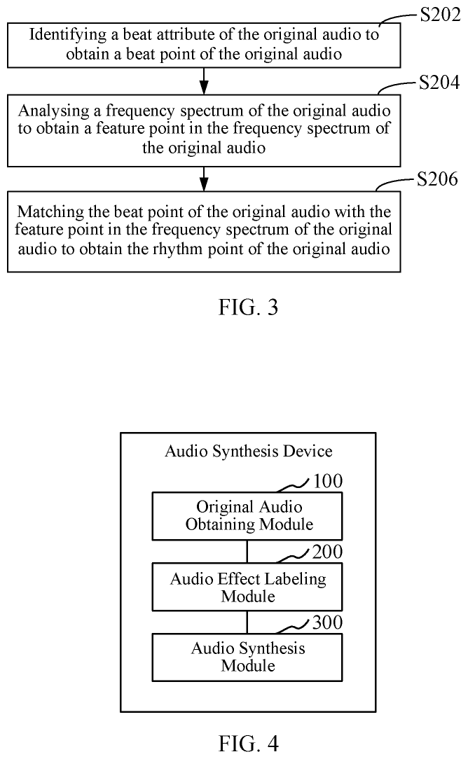

In an embodiment, referring to FIG. 3, the identifying the rhythm point in the original audio at step S204 may include the following steps.

At step S302, a beat attribute of the original audio is identified to obtain a beat point of the original audio.

Specifically, the beat attribute is referred to a BPM (marking the Beats Per Minute of music) attribute of the original audio. The identification of the BPM of the original audio may be performed by the terminal via common music analysing software, such as metronome, BPM test tool (MixMeister BPM Analyzer) and the like, thus the beat attribute of the original audio is obtained, and the beat point in the original audio characterizing the beat attribute is identified. Furthermore, the original audio of the song class often includes a main song, a chorus, an interlude, etc., in order to identify the rhythm attribute and to label the rhythm point of such original audio more accurately, the original song audio can be segmented according to the main song, the chorus, and the interlude. Then the audio section segmented can be identified by the BPM. At last, all of the segments of the BPM are fused, and the beat point of the original audio of the song class is finally obtained.

At step S304, a frequency spectrum of the original audio is analyzed to obtain a feature point in the frequency spectrum of the original audio.

Specifically, the server parses the frequency spectrum of the original audio according to the frequency spectrum analysis, which may be specifically implemented via the analysis method such as FFT (Fast Fourier Transformation) frequency spectrum analysis or by using the frequency spectrum analysis tool such as Cubase or the like. Further, the feature point in the frequency spectrum may be obtained by setting a feature point obtaining algorithm. For example, a point in the frequency spectrum, having a db (decibel) higher than a preset value obtained according to experience and experiment adjustments, may be regarded as a feature point.

At step S306, the original beat point is matched with the feature point in the frequency spectrum of the original audio to obtain the rhythm point.

Specifically, the terminal matches the beat point obtained at step S202 with the feature point obtained at step S204 to obtain the rhythm point of the original audio. Optionally, a point, where the beat point and the feature point coincide, may serve as the rhythm point.

In the above embodiment, the rhythm point of the original audio is eventually determined by the double-analysis on the beat attribute and frequency spectrum of the original audio, so as to obtain the rhythm point more precisely.

In an embodiment, the identifying the rhythm point of the original audio and labeling the audio effect area in the original audio according to the rhythm point at step S204 may specifically include: placing the original audio in a first audio track; identifying the rhythm point of the original audio in the first audio track, creating a second audio track corresponding the first audio track, and labeling the audio effect area corresponding to the rhythm point in the second audio track. The synthesizing the audio effect in the audio effect audio into the audio effect area in the original audio to obtain the synthesized audio at step S206 may include: extracting the to-be-added audio effect, and placing the to-be-added audio effect in the audio effect area; synthesizing the first audio track and the second audio track to obtain the synthesized audio.

The first audio track is configured to place and edit the original audio, while the second audio track is configured to place the audio effect audio. When adding the audio effect to the original audio, the server will place the original audio in the first audio track as the addition base, and the rhythm point of the original audio is identified in the first audio track according to the rhythm identifying algorithm or the method for identifying the rhythm point from step S302 to step S306. Then, the audio effect area is labeled in the blank second audio track synchronized with the first audio track according to the method for determining the audio effect area at step S204, and the audio effect audio is added to the audio effect area in the second audio track, while no content is added to the other areas other than the audio effect area in the second audio track. Finally, the first audio track and the second audio track are synthesized to obtain the synthesized audio. In addition, format conversion may be performed via audio processing software, when the storing formats of the original audio and the audio effect audio are different.

Furthermore, when the server needs to modify the audio effect area and the audio effect audio of the synthesized audio, the two tracks of the synthesized audio may be separated apart by a reverse operation of synthesizing. Then, the audio effect area or the audio effect audio added in the second audio track is adjusted to achieve the modification effect.

In the above embodiment, the synthesized audio is obtained by means of creating the first audio track to place the original audio without adding the audio effect, and the second audio track to place the to-be-added audio effect that is added to the original audio, and eventually synthesizing the two tracks. That is, a synthesized audio which can be directly played is obtained, thus facilitating the terminal to play and store the synthesized audio.

In an embodiment, after obtaining the synthesized audio at the above step S206, the method may further include: playing the synthesized audio; if a modification instruction to the synthesized audio is received, modifying the synthesized audio according to the modification instruction.

The modification instruction is an instruction sent to the server if the playing effect of the synthesized audio is not satisfied during playing the synthesized audio. This modification instruction may be an instruction to adjust the position of the added audio effect in the synthesized audio, or an instruction to replace or retract the audio effect audio added therein. In one embodiment, the modification instruction may be an instruction to adjust the audio effect area in the second audio track, or an instruction to replace the audio effect added to the second audio track.

In the above embodiment, after the server obtains the synthesized audio and before the server publishes the synthesized audio to other terminals for downloading, the playback effect of the synthesized audio needs to be verified. By the modification instruction, the position, the audio effect content or the like may be adjusted and modified, so that the playback effect becomes more complied with practical requirements.

In an embodiment, the above method for synthesizing the audio may further include generating a label file according to a position of the audio effect area in the original audio and the audio effect audio included in the synthesized audio.

The label file is a file configured to label the position of the audio effect added in the original audio and the added audio effect audio. In the label file, the audio effect area may be represented by a play time when the original audio is played. For example, a certain audio effect in the audio effect audio is added when the original audio is played from the first minute to the one minute three second. The added audio effect audio may be represented by a label. The label is a link type symbol for obtaining the audio effect audio. The server may acquire the audio effect audio corresponding to the label from a preset address storing a plurality of audio effect audios via the label. Optionally, the label of the audio effect audio may be represented by means of abbreviation, encoding or the like.

The label file may further include a non-audio-effect-area other than the audio effect area, and represent the non-audio-effect-area according to a time interval when the original audio is played. For example, a label file of an original audio may be represented as “empty[H], c1[k1], empty[HIJK], c2[k2], empty[HJK], c1[k1] . . . ”, wherein c1, c2 are indices of audio effect audios, which represent the audio effect audio files stored in the preset addresses. Empty represents a non-audio-effect-area, while a content in a square bracket behind an empty represents a time interval of the non-audio-effect-area. The contents in square bracket behind c1, c2 represent time intervals of audio effect areas. The label file may be stored in a format as a mid file or a xml file. The step of creating the above label file is the step of creating the corresponding mid file or xml file according to the original audio.

In the above embodiment, while the server obtains the synthesized audio, a label file may also be created according to the audio effect audio and audio effect area in the original audio where the audio effect is added during the process of synthesizing the audio, such that the condition of the addition of the audio effect in the synthesized audio can be recognized.

In an embodiment, the above method for synthesizing the audio may further include: obtaining the synthesized audio and the label file, and viewing the audio effect area and the audio effect audio in the synthesized audio according to the label file.

Specifically, after the server obtains the synthesized audio and the audio effect, which characterizes the audio effect audio and the audio effect area in the original audio where is added during the process of synthesizing the audio, the synthesized audio and the label file may be published correspondingly. The terminal may download the synthesized audio and the label file, play the synthesized audio, and obtain the detailed information of the audio synthesizing according to the label file. Optionally, when the terminal has an adjustment demand on the synthesized audio, it may send an adjustment request to the server according to the label file, and the server may respond to the adjustment request from the terminal and process accordingly.

In the above embodiment, an application of the synthesized audio is implemented via interactive operations between the server and the terminal.

In an embodiment, after the synthesized audio is obtained at step S206, the method may further include: obtaining a preset encryption algorithm, encrypting the synthesized audio and label file according to the preset encryption algorithm. After obtaining a synthesized audio and a label file after the above step, the method may further include: obtaining a decryption algorithm corresponding to the preset encryption algorithm; decrypting the encrypted synthesized audio and label file according to the decryption algorithm.

Specifically, the preset encryption algorithm, which may use the Base64 encryption algorithm or the like, is an algorithm encrypting the above label file and synthesized audio. The encryption algorithm may be selected according to the format of the synthesized audio and the label file, and the encryption algorithms for the both may be the same or different. The server may encrypt the synthesized audio and the label file using the preset encryption algorithm after obtaining the synthesized audio and the label file, and publish and transmit subsequently the encrypted files. When the encrypted synthesized audio and label file are downloaded and parsed by the terminal, it is required to only decrypt the encrypted synthesized audio and label file according to a decryption algorithm, such that the synthesized audio can then be played, and the label file may then be viewed.

In the above embodiment, by encrypting and decrypting the label file and the synthesized audio, the security during sharing and transmitting the original audio and the label file can be ensured.

It should be understood that although all of the steps in the flow diagrams of FIG. 2 to FIG. 3 are shown sequentially as the indication of the arrows, these steps do not have to be performed in such sequence as indicated by the arrows. Performing these steps does not have any sequential limitation such that these steps may be performed in another sequence, unless it is illustrated explicitly in the context. Moreover, at least a part of steps of FIG. 2 to FIG. 3 may include multiple sub-steps or multiple stages which may be performed at different times rather have to be accomplished at the same time, which may be performed in turn or alternately with the other steps or at least a part of the sub-steps or stages of the other steps, rather have to be performed sequentially.

In an embodiment, as shown in FIG. 4, a device for synthesizing an audio is provided. The device includes an original audio obtaining module 100, an audio effect area labeling module 200 and an audio synthesis module 300.

The original audio obtaining module 100 is configured to obtain an original audio.

The audio effect area labeling module 200 is configured to identify a rhythm point in the original audio, and label an audio effect area in the original audio according to the rhythm point.

The audio synthesis module 300 is configured to obtain an audio effect audio corresponding to the audio effect area, and synthesize the audio effect in the audio effect audio in the audio effect area in the original audio to obtain the synthesized audio.

In an embodiment, the audio effect area labeling module 200 in the above device for synthesizing the audio may include:

a beat identifying unit configured to identify a beat attribute of the original audio to obtain a beat point of the original audio;

a frequency spectrum analysing unit configured to analysing a frequency spectrum of the original audio to obtain a feature point in the frequency spectrum of the original audio;

a rhythm point obtaining unit configured to match the original beat point with the feature point in the frequency spectrum of the original audio to obtain the rhythm point of the original audio.

In an embodiment, the audio effect area labeling module 200 in the above device for synthesizing the audio may include:

a first audio track analysing unit configured to place the original audio in a first audio track;

a second audio track analysing unit configured to identify the rhythm point of the original audio in the first audio track, create a second audio track corresponding to the first audio track, and label the audio effect area in the second area corresponding to the rhythm point.

The audio synthesis module 300 may include:

an audio effect leading unit configured to extract an to-be-added audio effect from the audio effect audio and place the to-be-added audio effect in the audio effect area;

a synthesizing unit configured to synthesize the first audio track and the second audio track to obtain the synthesized audio.

In an embodiment, the above device for synthesizing the audio may further include:

an audio playback module configured to play the synthesized audio;

a modification module configured to modify the synthesized audio according to a modification instruction in response to receiving the modification instruction to the synthesized audio.

In an embodiment, the above device for synthesizing the audio may further include:

a label file creating module configured to create a label file according to a position of the audio effect area in the original audio and the audio effect audio included in the synthesized audio.

In an embodiment, the above device for synthesizing the audio may further include:

a file obtaining module configured to obtain the synthesized audio and the label file, and play the synthesized audio;

a file viewing module configured to view the audio effect audio and the audio effect area in the synthesized audio according to the label file.

In an embodiment, the above device for synthesizing the audio may further include:

an encryption module configured to obtain a preset encryption algorithm, and encrypt the synthesized audio and the label file according to the preset encryption algorithm;

a decryption algorithm obtaining module configured to obtain a decryption algorithm corresponding to the preset encryption algorithm;

a decryption algorithm configured to decrypt the encrypted synthesized audio and label file according to the decryption algorithm.

The specific definitions of the device for synthesizing the audio may refer to the above definitions of the method for synthesizing the audio, and details will not be described herein thereto. Each module in the above device for synthesizing the audio may be implemented in whole or in part by software, hardware and a combination thereof. Each of the above modules may be in a hardware form embedded in or independent of a processor in a computer apparatus, or may be in a software form stored in a memory in the computer apparatus, in order to be called by the processor to execute the operations corresponding to each of the above modules.

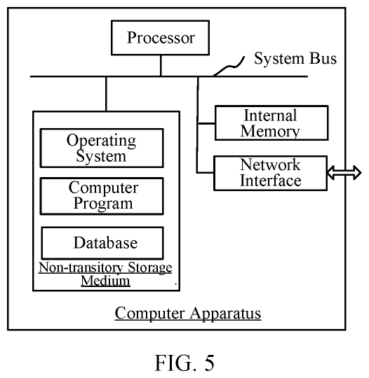

In an embodiment, a computer apparatus is provided. The computer apparatus may be a server. The internal structure diagram thereof may be as shown in FIG. 5. The computer apparatus includes a processor, a memory, a network interface, and a database, connected via a system bus. The processor of the computer apparatus is configured to provide computing and control capabilities. The memory of the computer apparatus includes a non-transitory storage medium, an internal memory. The non-transitory storage medium stores an operating system, a computer program, and a database. The internal memory provides an environment for the operation of the operating system and computer programs in the non-transitory storage medium. The database of the computer apparatus is configured to store the data for synthesizing the audio. The network interface of the computer apparatus is configured to communicatively connected to an external terminal via networks. The computer program is executed by the processor to implement a method for synthesizing an audio.

It will be understood by those skilled in the art that the structure shown in FIG. 5 is only a block diagram of a part of the structure related to the solution of the present application, and does not constitute a limitation of the computer apparatus to which the solution of the present application is applied. The specific computer apparatus may include more or fewer parts than shown in the figures, or combine some parts, or have different part arrangements.

In an embodiment, provided is a computer apparatus, including a memory having a computer program stored thereon, and a processor. The computer program implements the following steps when executed by the processor: obtaining an original audio; identify a rhythm point in the original audio, and labeling an audio effect area in the original audio according to the rhythm point; obtaining an audio effect audio corresponding to the audio effect area, synthesizing an audio effect in the audio effect audio in the audio effect area of the original audio to obtain a synthesized audio.

In an embodiment, the identifying the rhythm point in the original audio, which is implemented when the processor executes the computer program, includes: identifying a beat attribute of the original audio to obtain a beat point of the original audio; analysing a frequency spectrum of the original audio to obtain a feature point in the frequency spectrum of the original audio; matching the beat point of the original audio with the feature point in the frequency spectrum of the original audio to obtain the rhythm point of the original audio.

In an embodiment, the identifying the rhythm point in the original audio and labeling the audio effect area in the original audio according to the rhythm point, which is implemented when the processor executes the computer program, includes: placing the original audio in a first audio track; identifying the rhythm point of the original audio in the first audio track, creating a second audio track corresponding to the first audio track, and labeling the audio effect area corresponding to the rhythm point in the second audio track. The synthesizing the audio effect of the audio effect audio into the audio effect area of the original audio to obtain the synthesized audio, which is implemented when the processor executes the computer program, includes: extracting the to-be-added audio effect from the audio effect audio, and placing the to-be-added audio effect into the audio effect area; synthesizing the first audio track and the second audio track to obtain the synthesized audio.

In an embodiment, after obtaining the synthesized audio, which is implemented when the processor executes the computer program, the method may further include: playing the synthesized audio; during playing the synthesized audio, if a modification instruction on the synthesized audio is received, modifying the synthesized audio according to the modification instruction.

In an embodiment, the following step is further implemented when the processor executes the computer program: creating a label file according to a position of the audio effect area in the original audio and the audio effect audio included in the synthesized audio.

In an embodiment, the following step is further implemented when the processor executes the computer program: obtaining the synthesized audio and the label file, and playing the synthesized audio; viewing the audio effect audio and the audio effect area in the synthesized audio according to the label file.

In an embodiment, after obtaining the synthesized audio when the processor executes the computer program, the method further includes: obtaining a preset encryption algorithm, and encrypting the synthesized audio and the label file according to the preset encryption algorithm. Before obtaining the synthesized audio and the label file when the processor executes the computer program, the method further includes: obtaining a decryption algorithm corresponding to the preset encryption algorithm; decrypting the encrypted synthesized audio and label file according to the decryption algorithm.

In an embodiment, provided is a computer readable medium, including a memory having a computer program stored thereon, and a processor. The computer program implements the following steps when executed by the processor: obtaining an original audio; identify a rhythm point in the original audio, and labeling an audio effect area in the original audio according to the rhythm point; obtaining an audio effect audio corresponding to the audio effect area, synthesizing an audio effect in the audio effect audio in the audio effect area of the original audio to obtain a synthesized audio.

In an embodiment, the identifying the rhythm point in the original audio, which is implemented when the processor executes the computer program, includes: identifying a beat attribute of the original audio to obtain a beat point of the original audio; analysing a frequency spectrum of the original audio to obtain a feature point in the frequency spectrum of the original audio; matching the beat point of the original audio with the feature point in the frequency spectrum of the original audio to obtain the rhythm point of the original audio.

In an embodiment, the identifying the rhythm point in the original audio and labeling the audio effect area in the original audio according to the rhythm point, which is implemented when the processor executes the computer program, includes: placing the original audio in a first audio track; identifying the rhythm point of the original audio in the first audio track, creating a second audio track corresponding to the first audio track, and labeling the audio effect area corresponding to the rhythm point in the second audio track. The synthesizing the audio effect of the audio effect audio into the audio effect area of the original audio to obtain the synthesized audio, which is implemented when the processor executes the computer program, includes: extracting the to-be-added audio effect from the audio effect audio, and placing the to-be-added audio effect into the audio effect area; synthesizing the first audio track and the second audio track to obtain the synthesized audio.

In an embodiment, after obtaining the synthesized audio, which is implemented when the processor executes the computer program, the method may further include: playing the synthesized audio; during playing the synthesized audio, if a modification instruction to the synthesized audio is received, modifying the synthesized audio according to the modification instruction.

In an embodiment, the following step is further implemented when the processor executes the computer program: creating a label file according to a position of the audio effect area in the original audio and the audio effect audio included in the synthesized audio.

In an embodiment, the following step is further implemented when the processor executes the computer program: obtaining the synthesized audio and the label file, and playing the synthesized audio; viewing the audio effect audio and the audio effect area in the synthesized audio according to the label file.

In an embodiment, after obtaining the synthesized audio when the processor executes the computer program, the method further includes: obtaining a preset encryption algorithm, and encrypting the synthesized audio and the label file according to the preset encryption algorithm. Before obtaining the synthesized audio and the label file when the processor executes the computer program, the method further includes: obtaining a decryption algorithm corresponding to the preset encryption algorithm; decrypting the encrypted synthesized audio and label file according to the decryption algorithm.

A person skilled in the art should understand that the processes of the methods in the above embodiments could be, in full or in part, implemented by computer-readable instructions instructing underlying hardware. The computer-readable instructions can be stored in a computer-readable storage medium and executed by at least one processor in the computer operating system. The computer-readable instructions can include the processes in the embodiments of the various methods when it is being executed. Any references to memory, storage, databases, or other media used in various embodiments provided herein may include non-transitory and/or transitory computer-readable storage medium. Non-transitory computer-readable storage medium can include read only memory (ROM), programmable ROM (PROM), electrically programmable ROM (EPROM), electrically erasable programmable ROM (EEPROM), or flash memory. Transitory computer-readable storage medium may include random access memory (RAM) or external high-speed cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), synchronization chain Synchlink DRAM (SLDRAM), memory Bus (Rambus) direct RAM (RDRAM), direct memory bus dynamic RAM (DRDRAM), and memory bus dynamic RAM (RDRAM).

All technical features in the embodiments can be employed in arbitrary combinations. For purpose of simplifying the description, not all arbitrary combinations of the technical features in the embodiments illustrated above are described. However, as long as such combinations of the technical features are not contradictory, they should be considered as within the scope of the disclosure in the specification.

The above embodiments are merely illustrative of several implementations of the disclosure, and the description thereof is more specific and detailed, but should not be construed as limitations to the scope of the present disclosure. It should be noted that variations and improvements will become apparent to those skilled in the art to which the present disclosure pertains without departing from its scope. Therefore, the scope of the present disclosure is defined by the appended claims. cm What is claimed is:

1. An audio synthesis method, comprising:
obtaining an original audio;
identifying a rhythm point in the original audio, and labeling an audio effect area in the original audio according to the rhythm point; and
obtaining an audio effect audio corresponding to the audio effect area, and synthesizing an audio effect in the audio effect audio into the audio effect area of the original audio to obtain a synthesized audio.

2. The method of claim 1, wherein the identifying the rhythm point in the original audio comprises:
identifying a beat attribute of the original audio to obtain a beat point of the original audio;
analysing a frequency spectrum of the original audio to obtain a feature point in the frequency spectrum of the original audio; and
matching the beat point of the original audio with the feature point in the frequency spectrum of the original audio to obtain the rhythm point of the original audio.

3. The method of claim 1, wherein the identifying the rhythm point in the original audio, and labeling the audio effect area in the original audio according to the rhythm point comprises:
placing the original audio in a first audio track; and
identifying the rhythm point of the original audio in the first audio track, creating a second audio track corresponding to the first audio track, and labeling the audio effect area corresponding to the rhythm point in the second audio track;
wherein the synthesizing the audio effect in the audio effect audio into the audio effect area in the original audio to obtain the synthesized audio comprises:
extracting a to-be-added audio effect from the audio effect audio, and placing the to-be-added audio effect into the audio effect area; and
synthesizing the first audio track and the second audio track to obtain the synthesized audio.

4. The method of claim 1, wherein after obtaining the synthesized audio, the method further comprises:
playing the synthesized audio; and
modifying the synthesized audio according to a modification instruction in response to receiving the modification instruction to the synthesized audio.

5. The method of claim 1, further comprising:
creating a label file according to a position of the audio effect area in the original audio and the audio effect audio included in the synthesized audio.

6. The method of claim 5, comprising:
obtaining the synthesized audio and the label file; and
viewing the audio effect audio and the audio effect area in the synthesized audio according to the label file.

7. The method of claim 6, further comprising:
encrypting the synthesized audio and the label file according to a preset encryption algorithm;
wherein prior to the obtaining the synthesized audio and the label file, the method further comprises:
obtaining a decryption algorithm corresponding to the preset encryption algorithm; and
decrypting the encrypted synthesized audio and label file according to the decryption algorithm.

8. A computer apparatus, comprising:
one or more processors, and
a memory storing computer-readable instructions, which, when executed by the one or more processors cause the one or more processors to perform steps comprising:
obtaining an original audio;
identifying a rhythm point in the original audio, and labeling an audio effect area in the original audio according to the rhythm point; and
obtaining an audio effect audio corresponding to the audio effect area, and synthesizing an audio effect in the audio effect audio into the audio effect area of the original audio to obtain a synthesized audio.

9. The computer apparatus of claim 8, wherein the identifying the rhythm point in the original audio comprises:
identifying a beat attribute of the original audio to obtain a beat point of the original audio;
analysing a frequency spectrum of the original audio to obtain a feature point in the frequency spectrum of the original audio; and
matching the beat point of the original audio with the feature point in the frequency spectrum of the original audio to obtain the rhythm point of the original audio.

10. The computer apparatus of claim 8, wherein the identifying the rhythm point in the original audio, and labeling the audio effect area in the original audio according to the rhythm point comprises:
placing the original audio in a first audio track; and
identifying the rhythm point of the original audio in the first audio track, creating a second audio track corresponding to the first audio track, and labeling the audio effect area corresponding to the rhythm point in the second audio track;
wherein the synthesizing the audio effect in the audio effect audio into the audio effect area in the original audio to obtain the synthesized audio comprises:
extracting a to-be-added audio effect from the audio effect audio, and placing the to-be-added audio effect into the audio effect area; and
synthesizing the first audio track and the second audio track to obtain the synthesized audio.

11. The computer apparatus of claim 8, wherein after obtaining the synthesized audio, the steps further comprise:
playing the synthesized audio; and
modifying the synthesized audio according to a modification instruction in response to receiving the modification instruction to the synthesized audio.

12. The computer apparatus of claim 8, wherein the steps further comprise:
creating a label file according to a position of the audio effect area in the original audio and the audio effect audio included in the synthesized audio.

13. The computer apparatus of claim 12, wherein the steps further comprise:
obtaining the synthesized audio and the label file; and
viewing the audio effect audio and the audio effect area in the synthesized audio according to the label file.

14. The computer apparatus of claim 13, wherein the steps further comprise:
encrypting the synthesized audio and the label file according to a preset encryption algorithm;
wherein prior to the obtaining the synthesized audio and the label file, the steps further comprise:
obtaining a decryption algorithm corresponding to the preset encryption algorithm; and
decrypting the encrypted synthesized audio and label file according to the decryption algorithm.

15. At least one non-transitory computer-readable storage medium comprising computer-readable instructions, which, when executed by one or more processors, cause the one or more processors to perform steps comprising:
obtaining an original audio;
identifying a rhythm point in the original audio, and labeling an audio effect area in the original audio according to the rhythm point; and
obtaining an audio effect audio corresponding to the audio effect area, and synthesizing an audio effect in the audio effect audio into the audio effect area of the original audio to obtain a synthesized audio.

16. The storage medium of claim 15, wherein the identifying the rhythm point in the original audio comprises:
identifying a beat attribute of the original audio to obtain a beat point of the original audio;
analysing a frequency spectrum of the original audio to obtain a feature point in the frequency spectrum of the original audio; and
matching the beat point of the original audio with the feature point in the frequency spectrum of the original audio to obtain the rhythm point of the original audio.

17. The storage medium of claim 15, wherein the identifying the rhythm point in the original audio, and labeling the audio effect area in the original audio according to the rhythm point comprises:
placing the original audio in a first audio track; and
identifying the rhythm point of the original audio in the first audio track, creating a second audio track corresponding to the first audio track, and labeling the audio effect area corresponding to the rhythm point in the second audio track;
wherein the synthesizing the audio effect in the audio effect audio into the audio effect area in the original audio to obtain the synthesized audio comprises:
extracting a to-be-added audio effect from the audio effect audio, and placing the to-be-added audio effect into the audio effect area; and
synthesizing the first audio track and the second audio track to obtain the synthesized audio.

18. The storage medium of claim 15, wherein after obtaining the synthesized audio, the steps further comprise:
playing the synthesized audio; and
modifying the synthesized audio according to a modification instruction in response to receiving the modification instruction to the synthesized audio.

19. The storage medium of claim 15, wherein the steps further comprise:
creating a label file according to a position of the audio effect area in the original audio and the audio effect audio included in the synthesized audio.

20. The storage medium of claim 19, wherein the steps further comprise:
obtaining the synthesized audio and the label file; and
viewing the audio effect audio and the audio effect area in the synthesized audio according to the label file.
